(19) United States
(12) Patent Application Publication
(10) Pub. No.: US 2013/0084839 A1
(43) Pub. Date: Apr. 4, 2013

(54) SYSTEM AND METHOD FOR DELIVERING CALLER NAME INFORMATION TO MOBILE DEVICES

(71) Applicant: Mark H. Gosselin, Seattle, WA (US)

(72) Inventor: Mark H. Gosselin, Seattle, WA (US)

(21) Appl. No.: 13/251,604

(22) Filed: Oct. 3, 2011

(51) Int. Cl. H04W 4/16

(52) U.S. Cl. 455/415

(57) ABSTRACT

Systems and methods for delivering full name information to a mobile device are disclosed. A service control point receives a mobile dialing number (MDN) of an incoming call from a network control point, and queries a LIDB data store for partial name information. The network control point creates a call page including the partial name information and terminates the call to a terminating mobile device. The terminating mobile device opens a data connection to the service control point, and submits a query for full name information. The service control point retrieves the full name information from the LIDB data store, and transmits it to the terminating mobile device over the data connection.

### BACKGROUND

Traditional caller name identification on mobile telephone networks is performed in a network architecture using a pair of service points known as a network control point (NCP) and a service control point (SCP). The NCP manages signal traffic for terminating and connecting calls between carrier networks and to their subscribers. The SCP manages subscriber accounts and informatics for callers, including network-based caller information services.

This architecture permits various carrier networks to interoperate and to evaluate and apply appropriate rules using the caller and receiver telephone numbers (such as billing rates, roaming rates, and/or the like). Caller identification services may be applied at this juncture for call screening, as well, provided that the caller identification information associated with the caller's telephone number can be obtained quickly so as not to delay the call flow (such as initiation, connection, and termination of the call) between the carrier networks and, ultimately, connection to the receiver's handset. One standard for such caller identification services is Caller Name (CNAM). An example of a CNAM service is offered by Verisign®. Other CNAM providers include products and services from Targus® and Syniverse®.

CNAM provides caller name and city/state locations by querying a high speed, high volume data store, referred to as a line information database (LIDB) data store. In general, a CNAM service takes an incoming call from the NCP, sends call information (including the caller's number and the dialed number) to the SCP, determines that the query can be billed to the subscriber, determines which carrier the inbound call is coming from, makes the query to a service which can query name and phone number databases (such as the LIDB data store of the caller's carrier), resolves a name or a city/state pair for a phone number transiting the network, and sends that information along with the caller's Mobile Dialing Number (MDN) to the receiving handset for display when the call is received (typically during the incoming call ring).

Typically, a CNAM query should be completed in less than 2 seconds. This permits the caller to experience normal “ring tones” during the call, with no perceived delay to the calling parties, and for the calling handset to have its call connected to the receiver in a reasonable amount of time. Once terminated on the receiving carrier's NCP, the CNAM query result may be sent as a text string along with the caller's MDN to the receiver's phone in a call page data structure, and may be placed on the display of the receiving handset.

Unfortunately, the call page data structure only allows fifteen characters of CNAM data to be transmitted to the receiving handset, and so standard LIDB data stores only store fifteen characters of CNAM data for transmission. Though this limit was dictated in part by industry standards from the analog phone era, modifying existing wireless and landline telephone networks to display more than fifteen characters in the text field containing the name information would require a widespread programming effort across carriers and telephone companies that support the older standards. Moreover, such reprogramming could render many legacy receiving devices built for the legacy display nonfunctional for this type of call screening.

What is needed is a system and method that allows the handset to obtain and display full caller name data for call screening and other purposes while maintaining desired levels of responsiveness.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of retrieving caller data by code executing during execution of a call handler of a terminating mobile device is provided. A call page is received from a wireless network, wherein the call page is associated with an incoming call and includes a mobile directory number (MDN) of a calling mobile device. Caller data associated with the MDN is retrieved from a server over a wireless data connection, and the caller data is stored in a memory of the terminating mobile device.

In some embodiments, a service control point computing device is provided. The service control point includes at least one processor and a computer-readable medium having computer-executable instructions stored thereon that, if executed by the at least one processor, cause the service control point computing device to perform actions for providing caller name information to a terminating mobile device. The actions comprise receiving, from a network control point computing device, a subscriber query that includes a mobile dialing number (MDN) of a calling mobile device; submitting a query for caller name (CNAM) data to a LIDB data store associated with the MDN; transmitting, to the network control point computing device, the CNAM data received from the LIDB data store; receiving, from the terminating mobile device, a request for full name data; submitting a query for full name data to the LIDB data store associated with the MDN; and transmitting, to the terminating mobile device, the full name data received from the LIDB data store.

In some embodiments, a nontransitory computer-readable medium having computer-executable instructions stored thereon that, if executed by one or more processors of a mobile device, cause the mobile device to perform actions is provided. The actions comprise receiving, by the mobile device, a call page from a wireless network, wherein the call page is associated with an incoming call and includes a mobile directory number (MDN) of a calling mobile device; retrieving caller data associated with the MDN from a server over a wireless data connection; and storing the caller data in a memory of the terminating mobile device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates an overview of one embodiment of a mobile telephony system;

FIG. 2 is a block diagram that illustrates further details of one embodiment of the mobile telephony system of FIG. 1 according to various aspects of the present disclosure;

FIG. 3 is a block diagram that illustrates components of one embodiment of a terminating mobile device according to various aspects of the present disclosure;

FIGS. 4A-4B illustrate one embodiment of a method of delivering full name information to a terminating mobile device according to various aspects of the present disclosure; and

FIG. 5 illustrates aspects of an exemplary computing device appropriate for use with embodiments of the present disclosure.

### DETAILED DESCRIPTION

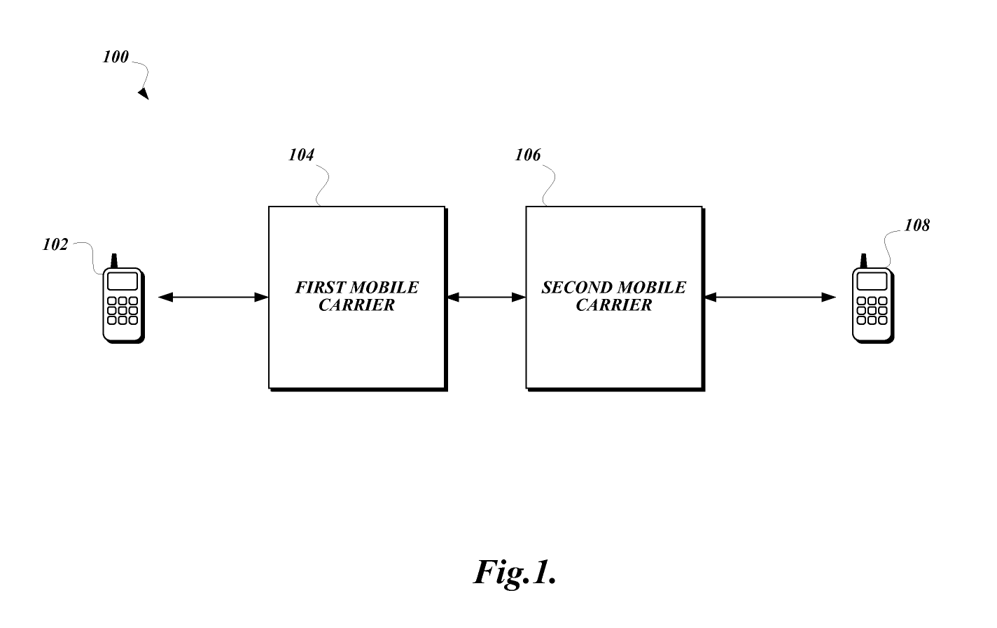

FIG. 1 is a block diagram that illustrates an overview of one embodiment of a mobile telephony system 100. A calling mobile device 102, such as a cell phone, smart phone, and/or the like, is associated with an account at a first mobile carrier 104 from which the calling mobile device 102 obtains wireless telephony service. A terminating mobile device 108, such as a cell phone, smart phone, and/or the like, is associated with an account at a second mobile carrier 106 from which the terminating mobile device 108 obtains wireless telephony service. When a user of the calling mobile device 102 places a call to the terminating mobile device 108, the first mobile carrier 104 connects to the second mobile carrier 106, and a communication channel is created between the calling mobile device 102 and the terminating mobile device 108 for transfer of telephony data between the devices.

In some embodiments, the first mobile carrier 104 servicing the calling mobile device 102 and the second mobile carrier 106 servicing the terminating mobile device 108 may, in fact, be the same mobile carrier. In such an embodiment, the connection between the first mobile carrier 104 and the second mobile carrier 106 is not used. In the examples below, embodiments in which the first mobile carrier 104 and the second mobile carrier 106 are separate are described primarily for ease of discussion, but one of ordinary skill in the art will appreciate that such examples may also be used in embodiments in which the first mobile carrier 104 and the second mobile carrier 106 are the same mobile carrier.

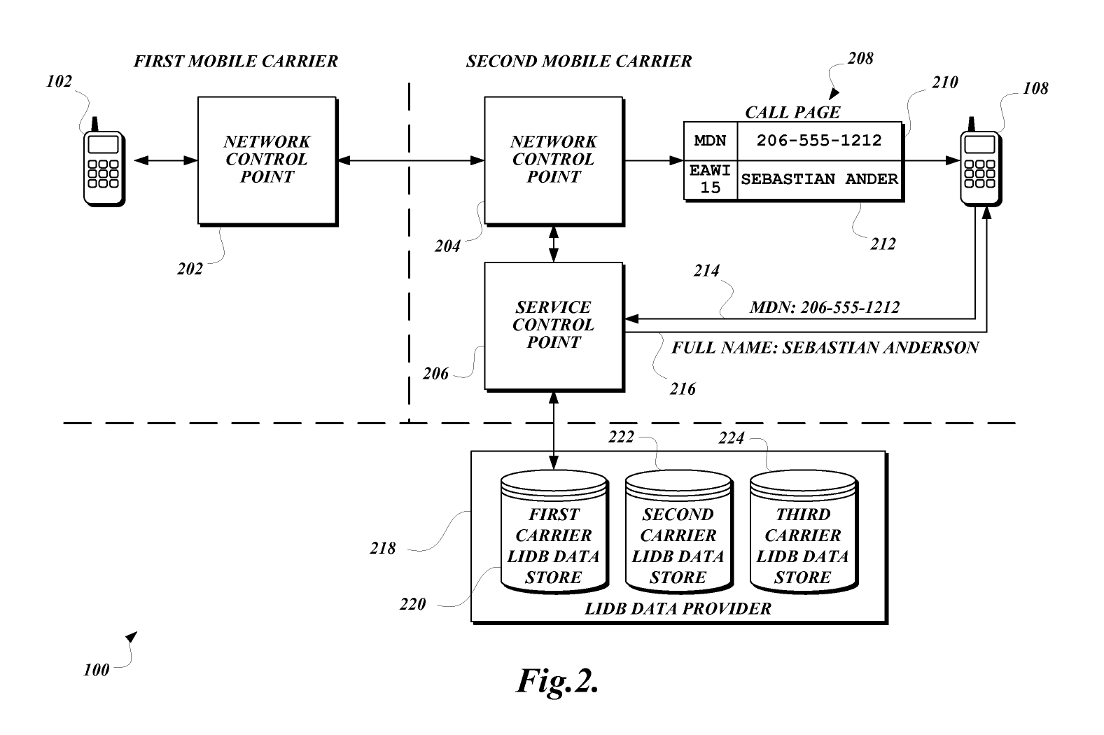

FIG. 2 is a block diagram that illustrates further details of the mobile telephony system 100. At each carrier, a network control point 202, 204 handles communication with mobile devices and with other network control points. As shown, the network control point 202 of the first mobile carrier 104 handles a connection to the calling mobile device 102, and the network control point 204 of the second mobile carrier 106 handles a connection to the terminating mobile device 108. Also, the network control point 202 of the first mobile carrier 104 connects to the network control point 204 of the second mobile carrier 106 to establish a communication channel between the carriers.

The network control point 204 terminates a call to the terminating mobile device 108 using standard telephony protocols. For example, embodiments of the present disclosure may terminate a call to the terminating mobile device 108 via CDMA, GSM, 3G, 4G, LTE, and/or any other past or future wireless communication protocol. In one embodiment, the terminating mobile device 108 may be a mobile telephone operating on a data-capable wireless network such as 3G, but this embodiment is exemplary only and other embodiments are contemplated within the present disclosure.

The second mobile carrier 106 also includes a service control point 206. As stated above, the service control point 206 may handle service information for subscribers of the second mobile carrier 106. For example, the service control point 206 may contain information about services, such as call waiting, caller ID, conference calling, data tethering, and/or the like, that are available to a given subscriber. The service control point 206 may provide these services to authorized subscribers, and/or may coordinate with the network control point 204 to provide such services to authorized subscribers.

For services that provide caller name information to the terminating mobile device 108 such as caller ID and/or the like, the service control point 206 may retrieve caller name information from a line information database (LIDB) data provider 218. A LIDB data provider 218 may store caller name information for multiple different carriers, and may store such information in separate data stores. As illustrated, the LIDB data provider 218 includes a first carrier LIDB data store 220 that contains caller name information for subscribers of the first mobile carrier 104. The illustrated LIDB data provider 218 also includes a second carrier LIDB data store 222 and a third carrier LIDB data store 224. In one embodiment, the second mobile carrier 106 communicates with the LIDB data provider 218 over a high speed packet switched network, but may also communicate with the LIDB data provider 218 via any suitable reliable high speed communication technique.

The first carrier LIDB data store 220 may include a field that contains CNAM data. CNAM data is standardized to contain fifteen characters of caller name information, and as such, often contains only partial name information. Typically, when terminating a call to the terminating mobile device 108 in a case where the subscriber has caller ID services, the service control point 206 queries the first carrier LIDB data store 220 for the CNAM data. The network control point 204 then creates a call page 208 that includes the mobile dialing number (MDN) value 210 that contains the MDN associated with the calling mobile device 102, and an extended alert with information (EAWI) value 212 that contains fifteen characters of caller name information, such as the fifteen characters stored in the CNAM field of the first carrier LIDB data store 220.

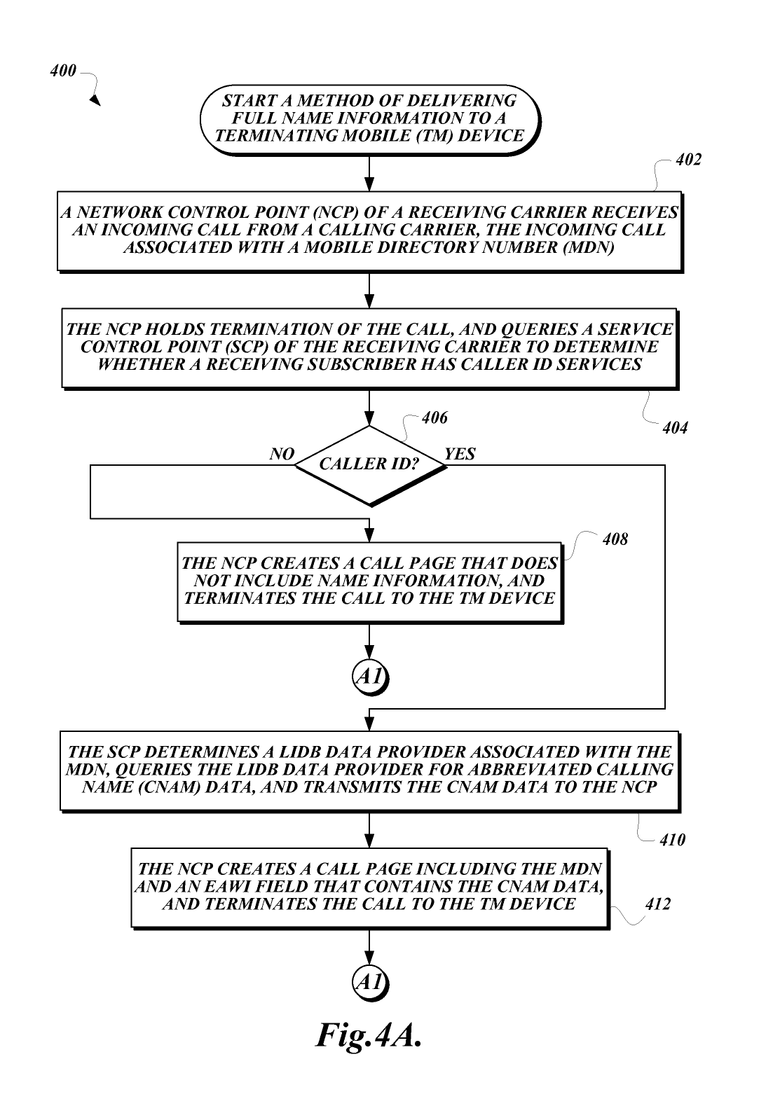

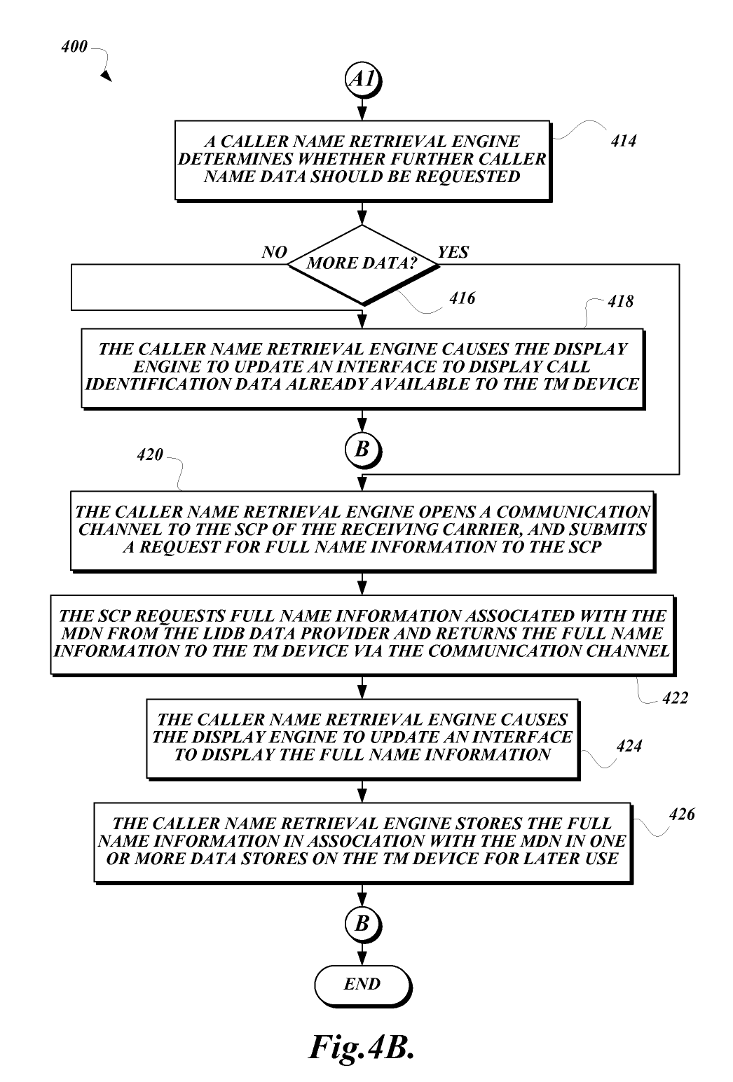

In some embodiments of the present disclosure, the terminating mobile device 108 may, upon receiving the call page 208, open a data connection to the service control point 206 to submit a full name query 214. A full name query 214 may be especially useful in cases in which the partial name information obtained through the call page 208 does not contain adequate information to identify the caller. In response, the service control point 206 may retrieve additional caller name information from the first carrier LIDB data store 220, such as caller name information stored in an EX-CNAM field. The EX-CNAM caller name information may include more than the fifteen characters stored in the CNAM field and included in the call page 208. The service control point 206 then transmits the full name information back to the terminating mobile device 108 in a full name response 216. Methods for transmitting this full name information to the terminating mobile device 108 are described further below with respect to FIGS. 4A-4B.

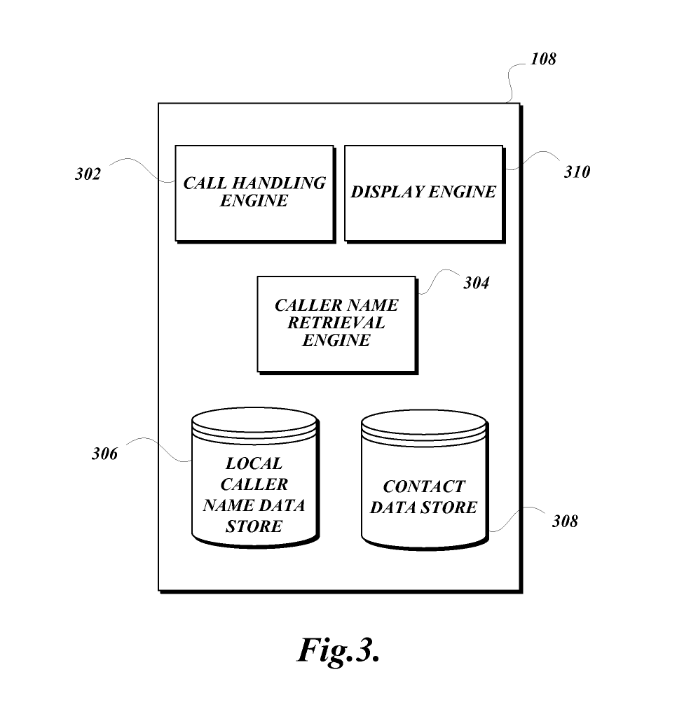

FIG. 3 is a block diagram that illustrates components of one embodiment of a terminating mobile device 108 according to various aspects of the present disclosure. The terminating mobile device 108 includes a call handling engine 302, a display engine 310, and a caller name retrieval engine 304. The call handling engine 302 may be configured to receive the incoming call page from the network control point 204. Once the call handling engine 302 receives the call page 208, the call handling engine 302 may instruct the display engine 310 to present information associated with the call page 208, such as the MDN value 210 or the CNAM information from the EAWI value 212, to a user. The caller name retrieval engine 304 may inspect the call page 208 and decide whether to obtain further name information from the service control point 206, and may do at any time. That is, in some embodiments, the caller name retrieval engine 304 may submit the full name query 214 to the service control point 206 during the call, including during the incoming call sequence before the call is picked up by a user of the terminating mobile device 108.

The terminating mobile device 108 may also include a local caller name data store 306 and a contact data store 308. Once the caller name retrieval engine 304 obtains the full name response 216, the caller name retrieval engine 304 may store the full name information along with the MDN in the local caller name data store 306 so that the full name information may be displayed during a subsequent call before a full name response 216 is received from the service control point 206. The stored full name information may be checked against a subsequent full name response 216 and updated with the contents of the subsequent full name response 216 when the stored information has become stale, such as after a set number of calendar days, after the MDN has not been used in at least a set number of calendar days, and/or the like.

The caller name retrieval engine 304 may also provide a user the option of storing the full name information in a contact data store 308 so that the user may have the name and MDN in a contact list. The presence of full name information in the contact data store 308 for a given MDN may be used to prevent, override, or cancel the caller name retrieval engine 304 from retrieving further name information from the service control point 206 when appropriate, such as when it is deemed important to conserve use of the data channel, bandwidth usage, battery power, and/or the like.

More details of these storage actions are discussed below with respect to FIGS. 4A-4B.

As recognized by one of ordinary skill in the art, the mobile carriers 104, 106 and the terminating mobile device 108 may utilize further components in addition to the ones illustrated herein, and/or components illustrated herein as separate components may be merged to form unitary components, without departing from the scope of the present disclosure.

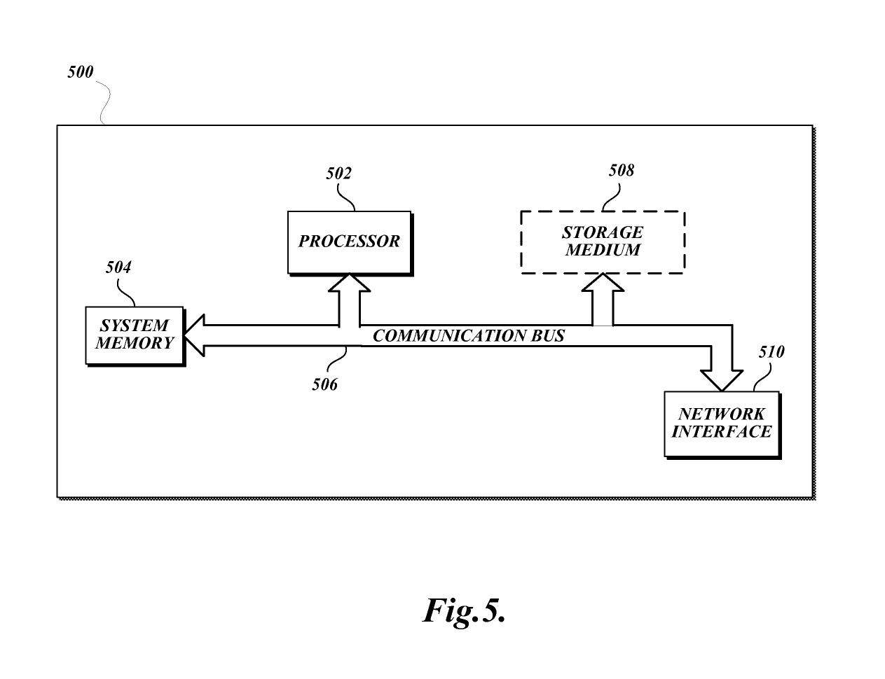

In one embodiment, the calling mobile device 102, the terminating mobile device 108, the first mobile carrier 104, the second mobile carrier 106 (and/or individual components thereof), and/or the LIDB data provider 218 may be implemented using one or more computing devices, as discussed further below with respect to FIG. 5. In one embodiment, the separate illustrated components of the second mobile carrier 106 may be combined within a single computing device, or may be implemented on separate computing devices that communicate via a local area network, a wide area network, a WiFi network, and/or any other suitable communication technique. Communication between the calling mobile device 102 and the first mobile carrier 104 may occur via any suitable telephony protocol.

Embodiments of the present disclosure may use an incoming telephone number, denominated as a CLID, ANI, CID, and/or the like by various network standards, as an MDN. The CLID, ANI, CID, and/or the like is provided as a standard interoperability practice by many types of telephone networks, and therefore one of ordinary skill in the art will recognize that embodiments of the present disclosure may be used with incoming calls from many types of networks. For example, the incoming call may be made using conventional analog telephone networks, cellular networks, IP-based networks, VoIP networks, and/or the like. In this regard, the calling mobile device 102 and the first mobile carrier 104 are merely examples illustrating the initiation of an incoming call and an associated number, as is the initiation of an incoming call from mobile device 102 via network control point 202 in FIG. 2. These illustrations are exemplary only, and should not be construed as limiting.

FIGS. 4A-4B illustrate one embodiment of a method 400 of delivering full name information to a terminating mobile device 108, according to various aspects of the present disclosure. From a start block (FIG. 4A), the method 400 proceeds to block 402, where a network control point 204 of a receiving carrier (such as second mobile carrier 106 illustrated above) receives an incoming call from a calling carrier (such as first mobile carrier 104 illustrated above), the incoming call associated with a mobile directory number (MDN). In block 404, the network control point 204 holds termination of the call, and queries a service control point 206 of the receiving carrier to determine whether a receiving subscriber has caller ID services. In some embodiments, the query sent to the service control point 206 may include the MDN and a phone number of the terminating mobile device 108.

In decision block 406, a test may be performed to determine whether the service control point 206 has indicated that the receiving subscriber has caller ID services (or some similar service). If the answer to the test at decision block 406 is NO, then name services will not be supplied by the receiving carrier to the terminating mobile device 108. Accordingly, the method 400 proceeds to block 408, where the network control point 204 creates a call page that does not include name information and terminates the call to the terminating mobile device 108. Termination of the call includes transmitting the call page that does not include name information to the terminating mobile device 108. The method 400 then proceeds to a continuation terminal (“terminal A1”).

If the answer to the test at decision block 406 is YES, then the method 400 proceeds to block 410, where the service control point 206 determines a LIDB data provider 218 associated with the MDN. The service control point 206 queries the LIDB data provider 218 for abbreviated calling name data (such as CNAM data), and transmits the CNAM data to the network control point 204. Next, at block 412, the network control point 204 creates a call page 208 that includes the MDN 210 and an extended alert with information (EAWI) field 212 that contains the CNAM data. The network control point 204 terminates the call to the terminating mobile device 108, which includes transmitting the call page 208 to the terminating mobile device 108. The method 400 then proceeds to a continuation terminal (“terminal A1”).

From terminal A1 (FIG. 4B), the method 400 proceeds to block 414, where a caller name retrieval engine 304 of the terminating mobile device 108 determines whether further caller name data should be requested. In one embodiment, the terminating mobile device 108 bases the determination on the information included with the call page 208. For example, the terminating mobile device 108 may determine that further caller name data should be requested only if the call page 208 includes an EAWI field 212. If the call page 208 does not include an EAWI field 212, it would indicate that caller name services are not available to the terminating mobile device 108, and so attempting to retrieve further name data from the receiving carrier would be fruitless. In other embodiments, the decision to obtain further caller name data may be based on contents of the EAWI field 212, and/or may be based on other factors such as whether data associated with the MDN is already available in a local caller name data store 306, whether a refresh is indicated by a schedule, whether user modifications have been made to the local caller name data store 306, and/or the like.

In decision block 416, a test is performed based on the determination performed in block 414. If the determination whether further caller name data should be requested is NO, the method 400 proceeds to block 418, where the caller name retrieval engine 304 causes the display engine 310 to update an interface to display call identification data already available to the terminating mobile device 106. In one embodiment, this information may simply be the MDN. In other embodiments, the MDN may be replaced or supplemented with other information available to the terminating mobile device 106. For example, if name information associated with the MDN is stored in a local caller name data store 306 or a contact data store 308, the display engine 310 may update the interface to include such information. As another example, if the terminating mobile device 106 has local access to city and/or state information associated with the MDN, the display engine 310 may update the interface to include such information. The method 400 then proceeds to a continuation terminal (“terminal B”).

If the determination whether further caller name data should be requested is YES, the method 400 proceeds to block 420, where the caller name retrieval engine 304 opens a communication channel to the service control point 206 of the receiving carrier, and submits a request for full name information to the service control point 206. In some embodiments, the communication channel is an IP-based communication channel, though other data exchange protocols may be used. In some embodiments (such as those operating on 3G, 4G, or LTE wireless networks), the IP-based communication channel is opened after termination of the call but before completion of the call. If the IP-based communication channel is opened soon enough after call termination, the full name information may be made available before the subscriber picks up the call in order to provide call screening functionality. In other embodiments, the IP-based communication channel may be opened after termination of the call, and the full name information may be stored by the terminating mobile device 106 for use during subsequent calls.

Next, at block 422, the service control point 206 requests full name information associated with the MDN from the LIDB data provider 218 and returns the full name information to the terminating mobile device 108 via the communication channel. As discussed above, the service control point 206 may specify a particular LIDB data store from which the full name information should be retrieved by the LIDB data provider 218. In some embodiments, the full name information may be made available by the same data store as the abbreviated CNAM information, and may be stored in an extended CNAM or EX-CNAM field. The method 400 proceeds to block 424, where the caller name retrieval engine 424 causes the display engine 310 to update an interface to display the full name information received from the service control point 206. Next, at block 426, the caller name retrieval engine 304 may store the full name information in association with the MDN in one or more data stores on the terminating mobile device 108, such as the local caller name data store 306 or the contact data store 308, for later use. The method 400 then proceeds to terminal B, and then to an end block where the method 400 terminates.

In the embodiment illustrated and discussed above, the retrieval of the full name information and the transmission of the full name information to the terminating mobile device 108 may be performed after call termination but before the call is picked up. This technique may be used to improve the user experience with relation to call termination speed, though the full name information may not be obtained and transmitted to the terminating mobile device 108 by the time the call is picked up. In another embodiment, actions related to obtaining full name information and transmitting the information to the terminating mobile device 108 happen before the call is terminated. In such an embodiment, the service control point 206 may wait until the full name information has been obtained before instructing the network control point 204 to terminate the call. The service control point 206 may then provide the full name information in response to the full name query from the terminating mobile device 108 without having to submit a query to the LIDB data provider 218.

FIG. 5 illustrates aspects of an exemplary computing device 500 appropriate for use with embodiments of the present disclosure. While FIG. 5 is described with reference to a computing device that is implemented as a device on a network, the description below is applicable to servers, personal computers, mobile phones, smart phones, and other devices that may be used to implement portions of embodiments of the present disclosure. Moreover, those of ordinary skill in the art and others will recognize that the computing device 500 may be any one of any number of currently available or yet to be developed devices.

In its most basic configuration, the computing device 500 includes at least one processor 502 and a system memory 504 connected by a communication bus 506. Depending on the exact configuration and type of device, the system memory 504 may be volatile or nonvolatile memory, such as read only memory (“ROM”), random access memory (“RAM”), EEPROM, flash memory, or similar memory technology. Those of ordinary skill in the art and others will recognize that system memory 504 typically stores data and/or program modules that are immediately accessible to and/or currently being operated on by the processor 502. In this regard, the processor 502 may serve as a computational center of the computing device 500 by supporting the execution of instructions.

As further illustrated in FIG. 5, the computing device 500 may include a network interface 510 comprising one or more components for communicating with other devices over a network. Embodiments of the present disclosure may access basic services that utilize the network interface 510 to perform communications using common network protocols. The network interface 510 may also include a wireless network interface configured to communicate via one or more wireless communication protocols.

In the exemplary embodiment depicted in FIG. 5, the computing device 500 also includes a storage medium 508. However, services may be accessed using a computing device that does not include means for persisting data to a local storage medium. Therefore, the storage medium 508 depicted in FIG. 5 is represented with a dashed line to indicate that the storage medium 508 is optional. In any event, the storage medium 508 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 508.

As used herein, the term “computer-readable medium” includes volatile and non-volatile and removable and non-removable media implemented in any method or technology capable of storing information, such as computer readable instructions, data structures, program modules, or other data. In this regard, the system memory 504 and storage medium 508 depicted in FIG. 5 are merely examples of computer-readable media.

Suitable implementations of computing devices that include a processor 502, system memory 504, communication bus 506, storage medium 508, and network interface 510 are known and commercially available. For ease of illustration and because it is not important for an understanding of the claimed subject matter, FIG. 5 does not show some of the typical components of many computing devices. In this regard, the computing device 500 may include input devices, such as a keyboard, keypad, mouse, microphone, touch input device, touch screen, tablet, and/or the like. Such input devices may be coupled to the computing device 500 by wired or wireless connections including RF, infrared, serial, parallel, Bluetooth, B, or other suitable connections protocols using wireless or physical connections. Similarly, the computing device 500 may also include output devices such as a display, speakers, printer, etc. Since these devices are well known in the art, they are not illustrated or described further herein.

In general, the word “engine” (used interchangeably with the word application or module), as used herein, refers to logic embodied in hardware or software instructions, which can be written in a programming language, such as C, C++, COBOL, JAVA™, PHP, Perl, HTML, CSS, JavaScript, VBScript, ASPX, Microsoft.NET™, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications can be stored in any type of computer-readable medium or computer storage device and be stored on and executed by one or more general purpose computers, thus creating a special purpose computer configured to provide the engine or application.

While illustrative embodiments have been illustrated and described, it will be appreciated that various changes can be made therein without departing from the spirit and scope of the invention.

1. A computer-implemented method of retrieving caller data by code executing during execution of a call handler of a terminating mobile device, the method comprising:
receiving, by the terminating mobile device, a call page from a wireless network, wherein the call page is associated with an incoming call and includes a mobile directory number (MDN) of a calling mobile device;
transmitting, by the terminating mobile device, a query for caller data associated with the MDN to a server on the wireless network over a wireless data connection; and
storing, by the terminating mobile device, the caller data in a memory of the terminating mobile device.

2. The method of claim 1, wherein transmitting a query for caller data associated with the MDN to a server over a wireless data connection includes opening a wireless data connection to the server before the incoming call associated with the call page is completed.

3. The method of claim 1, further comprising presenting the caller data to a user of the terminating mobile device before the user picks up the incoming call.

4. The method of claim 1, wherein the call page includes abbreviated caller name (CNAM) data retrieved from a line information database (LIDB) data store, wherein the CNAM data includes fifteen characters or less of caller name information.

5. The method of claim 4, wherein the caller data retrieved from the server includes extended caller name (EX-CNAM) data, wherein the EX-CNAM data includes more than fifteen characters of caller name information.

6. The method of claim 5, wherein the EX-CNAM data is retrieved from the line information database (LIDB) data store from which the CNAM data was retrieved.

7. The method of claim 1, wherein the server is a service control point (SCP) server associated with a carrier of the terminating mobile device.

8. A service control point computing device, comprising:
at least one processor; and
a computer-readable medium having computer-executable instructions stored thereon that, if executed by the at least one processor, cause the service control point computing device to perform actions for providing caller name information to a terminating mobile device, the actions comprising:
receiving, from a network control point computing device, a subscriber query that includes a mobile dialing number (MDN) of a calling mobile device;
submitting a query for caller name (CNAM) data to a line information database (LIDB) data store associated with the MDN;
transmitting, to the network control point computing device, the CNAM data received from the LIDB data store;
receiving, from the terminating mobile device, a request for full name data;
submitting a query for full name data to the LIDB data store associated with the MDN; and
transmitting, to the terminating mobile device, the full name data received from the LIDB data store.

9. The service control point computing device of claim 8, wherein the actions further comprise determining whether a subscriber associated with the terminating mobile device has access to caller name services, and wherein submitting the query for caller name (CNAM) data to a line information database (LIDB) data store associated with the MDN is performed in response to determining that the subscriber has access to caller name services.

10. The service control point computing device of claim 8, wherein the full name data includes extended caller name (EX-CNAM) data.

11. The service control point computing device of claim 8, wherein the actions further comprise establishing a data connection with the terminating mobile device.

12. The service control point computing device of claim 11, wherein establishing a data connection with the terminating mobile device includes establishing an IP-based connection with the terminating mobile device.

13. The service control point computing device of claim 11, wherein establishing the data connection with the terminating mobile device includes establishing the data connection with the terminating mobile device while the terminating mobile device is participating in a call.

14. The service control point computing device of claim 8, wherein the CNAM data is fifteen characters or less, and wherein the full name data includes more than fifteen characters.

15. A nontransitory computer-readable medium having computer-executable instructions stored thereon that, if executed by one or more processors of a mobile device, cause the mobile device to perform actions comprising:
receiving, by the mobile device, a call page from a wireless network, wherein the call page is associated with an incoming call and includes a mobile directory number (MDN) of a calling mobile device;
transmitting, by the mobile device, a query for caller data associated with the MDN to a server on the wireless network over a wireless data connection; and
storing, by the mobile device, the caller data in a memory of the mobile device.

16. The computer-readable medium of claim 15, wherein transmitting a query for caller data associated with the MDN to a server on the wireless network over a wireless data connection includes opening, by the mobile device, a wireless data connection to the server before the call associated with the call page is completed.

17. The computer-readable medium of claim 15, wherein the actions further comprise presenting, by the mobile device, the caller data to a user of the mobile device before the user picks up the incoming call.

18. The computer-readable medium of claim 15, wherein the call page includes abbreviated caller name (CNAM) data retrieved from a line information database (LIDB) data store.

19. The computer-readable medium of claim 18, wherein the caller data retrieved from the server includes extended caller name (EX-CNAM) data.

20. The computer-readable medium of claim 19, wherein the EX-CNAM data is retrieved from the line information database (LIDB) data store from which the CNAM data was retrieved.
